(19) United States
(12) Patent Application Publication
(10) Pub. No.: US 2021/0199216 A1
(43) Pub. Date: Jul. 1, 2021

(54) BRAKE HOSE AND CROSSLINKED RUBBER COMPOSITION

(71) Applicant: TOYODA GOSEI CO., LTD., Kiyosu-shi (JP)

(72) Inventors: Hiroko HISANAGA, Kiyosu-shi (JP); Yasuhiro TERANISHI, Kiyosu-shi (JP)

(21) Appl. No.: 17/129,293

(22) Filed: Dec. 21, 2020

(30) Foreign Application Priority Data
Dec. 26, 2019 (JP) 2019-235670

(51) Int. Cl. F16L 11/08; C08L 23/16

(52) U.S. Cl. CPC F16L 11/081; C08L 2312/00; C08L 2205/025; C08L 23/16

(57) ABSTRACT

A crosslinked rubber composition for a brake hose includes ethylene α-olefin diene rubber and carbon black. The ethylene α-olefin diene rubber contains ethylene propylene diene rubber (EPDM) and ethylene butene diene rubber (EBDM), and the mass ratio of EPDM/EBDM is 30/70 to 80/20. The carbon black contains only specific carbon black exhibiting an iodine adsorption amount of 15 to 33 mg/g and a DBP absorption amount of 50 to 155 cm³/100 g. The crosslinked rubber composition exhibits a T10 of −50° C. or less as determined by a Gehman torsion test and a volume specific resistance of 1.5×10⁵ Ω·cm or more.

### TECHNICAL FIELD

The present invention relates to a brake hose and a crosslinked rubber composition used in a rubber layer of the brake hose.

### BACKGROUND ART

A brake hose generally includes at least an outer rubber layer, an inner rubber layer, and a reinforcing yarn layer, and the reinforcing yarn layer is disposed between the outer rubber layer and the inner rubber layer. The brake hose is formed so as to retain a brake fluid inside the inner rubber layer. As described in Patent Document 1, many current brake hoses have a five-layer structure including an outer rubber layer, an outer reinforcing yarn layer, an intermediate rubber layer, an inner reinforcing yarn layer, and an inner rubber layer, wherein these layers are sequentially inwardly disposed in a concentric manner. Each rubber layer is generally formed of a vulcanized (crosslinked) rubber composition containing ethylene propylene diene rubber (EPDM) and carbon black for achieving physical properties such as rigidity.

A brake hose has at its end a connecting cap formed of a metal. The cap is strongly tightened by swaging at the end of the brake hose so as to seal between the cap and the hose and to prevent entrance of a brake fluid from the end of the hose into a yarn layer between rubber layers.

### CITATION LIST

### Patent Documents

[Patent Document 1] Japanese Unexamined Patent Application Publication No. No. 2010-230075

### SUMMARY OF THE INVENTION

### Technical Problem

Even when the brake hose is used under normal conditions, the rubber layer inevitably undergoes gradual deterioration of sealability due to, for example, thermal degradation. When the brake hose is used in a cold area, the respective rubber layers are hardened at low temperature, leading to impaired rubber elasticity and poor sealability. This may cause entrance of a brake fluid from the end of the hose into the yarn layer between the rubber layers, resulting in swelling of the outer layer.

Since each rubber layer is formed of a crosslinked rubber composition containing carbon black as described above, the rubber layer exhibits high electrical conductivity. Thus, deposition of water around the cap may cause a problem in that electricity is conducted between the rubber layer and the cap, and electrical corrosion occurs at the cap.

In view of the foregoing, an object of the present invention is to achieve a superior brake hose which is less likely to cause hardening of a rubber layer, reduction in elasticity, and deterioration of sealability even at low temperatures, resulting in being able to prevent entrance of a brake fluid from the end of the hose into a yarn layer between rubber layers even when used in a cold area, and which can achieve low electrical conductivity without deterioration of physical properties (e.g., rigidity) of the rubber layer, resulting in being less likely to cause electrical corrosion at a cap attached to the end of the hose.

### Solution to Problem

<1> Crosslinked Rubber Composition for Brake Hose

A crosslinked rubber composition for a brake hose, the crosslinked rubber composition containing ethylene α-olefin diene rubber and carbon black, wherein:

the ethylene α-olefin diene rubber contains ethylene propylene diene rubber (EPDM) and ethylene butene diene rubber (EBDM), and the mass ratio of EPDM/EBDM is 30/70 to 80/20;

the carbon black contains only specific carbon black exhibiting an iodine adsorption amount of 15 to 33 mg/g and a DBP absorption amount of 50 to 155 cm³/100 g; and

the crosslinked rubber composition exhibits a T10 of −50° C. or less as determined by a Gehman torsion test and a volume specific resistance of 1.5-10⁵ Ω·cm or more.

Preferably, the specific carbon black exhibits an iodine adsorption amount of 15 to 30 mg/g and a DBP absorption amount of 100 to 155 cm³/100 g, and the crosslinked rubber composition exhibits a 100% modulus (M100) of 3.2 MPa or more.

<2> Brake Hose

A brake hose including at least an outer rubber layer (outer skin rubber layer), an inner rubber layer (inner tube rubber layer), and a reinforcing yarn layer disposed between the outer rubber layer and the inner rubber layer, the brake hose being formed so as to retain a brake fluid inside the inner rubber layer, wherein:

at least one of the outer rubber layer and the inner rubber layer is formed of the crosslinked rubber composition described above in <1>.

Preferably, both the outer rubber layer and the inner rubber layer are formed of the crosslinked rubber composition described above in <1>, and the crosslinked rubber composition for the inner rubber layer contains an oil in an amount of less than 1 part by weight.

The inner rubber layer undergoes a change in physical properties through extraction of the oil over time by a brake fluid present inside the inner rubber layer. Thus, a change in physical properties is reduced by previously decreasing the amount of the oil contained in the inner rubber layer.

[Effects]

Since EBDM exhibits higher molecular mobility than EPDM at low temperature, a mass ratio of EPDM/EBDM of 30/70 to 80/20 leads to an improvement in the low-temperature physical properties of the vulcanized rubber. This effect is reduced when the proportion of EBDM is less than 20 in the aforementioned ratio.

Mixing of EBDM with EPDM causes an improvement in the flex fatigue resistance of the vulcanized rubber. Thus, when the mass ratio of EPDM/EBDM is 30/70 to 80/20, the vulcanized rubber exhibits improved low-temperature physical properties and improved flex fatigue resistance. The effect of improving flex fatigue resistance is reduced when the proportion of EPDM is less than 30 in the aforementioned ratio.

Carbon black having a large particle diameter exhibits good dispersibility in rubber, and particles of carbon black having a small structure are separated from one another. Thus, incorporation of such carbon black into rubber increases the electric resistance of the rubber.

Since carbon black having a large particle diameter tends to exhibit a small iodine adsorption amount, the iodine adsorption amount serves as an index of particle diameter. Meanwhile, since carbon black having a large structure tends to exhibit a large DBP absorption amount, the DBP absorption amount serves as an index of structure.

On the basis of extensive studies, the present invention involves the use of carbon black exhibiting an iodine adsorption amount (JIS K6217-1: 2008) of 15 to 33 mg/g and a DBP absorption amount (JIS K6217-4: 2017) of 50 to 155 cm³/100 g as “specific carbon black.” This specific carbon black exhibits excellent dispersibility in rubber, and particles of the carbon black are separated from one another. Thus, incorporation of only the specific carbon black into rubber increases the electric resistance of the rubber. An iodine adsorption amount of less than 15 mg/g leads to a reduction in rigidity (i.e., HA, TB, and M100 described below), whereas an iodine adsorption amount of more than 33 mg/g leads to a decrease in electric resistance. A DBP absorption amount of less than 50 cm³/100 g leads to a reduction in rigidity (i.e., HA, TB, and M100 described below), whereas a DBP absorption amount of more than 155 cm³/100 g leads to a decrease in electric resistance.

### Advantageous Effects of Invention

The present invention can provide a superior brake hose which is less likely to cause hardening of a rubber layer, reduction in elasticity, and deterioration of sealability even at low temperatures, resulting in being able to prevent entrance of a brake fluid from the end of the hose into a yarn layer between rubber layers even when used in a cold area, and which can achieve low electrical conductivity without deterioration of physical properties (e.g., rigidity) of the rubber layer, resulting in being less likely to cause electrical corrosion at a cap attached to the end of the hose.

### BRIEF DESCRIPTION OF DRAWINGS

FIG. 1A shows an end-broken perspective view of a brake hose of an example, and FIG. 1B shows a half cross-sectional view of the brake hose of the example; and

FIG. 2 is a graph showing the relationship between the iodine adsorption amount of carbon black used in each of Examples 3 and 6 and Comparative Examples 2 and 6 and the common logarithm of the volume specific resistance of a vulcanized rubber composition.

### DESCRIPTION OF EMBODIMENTS

<1> Crosslinked Rubber Composition for Brake Hose

No particular limitation is imposed on the type of EPDM, but preferred EPDM has an ethylene content of 41 to 69% by mass and a diene content of 2.7 to 14% by mass.

No particular limitation is imposed on the type of EBDM, but preferred EBDM has an ethylene content of 41 to 69% by mass and a diene content of 2.7 to 14% by mass.

The crosslinked rubber composition may contain only EPDM and EBDM as rubber polymers, or may contain an additional rubber polymer besides EPDM and EBDM.

No particular limitation is imposed on the amount of specific carbon black relative to 100 parts by mass of the rubber polymers. The amount of specific carbon black is preferably 50 to 100 parts by mass in view of the balance between reinforcement and low electrical conductivity. An increase in the amount of specific carbon black leads to an increase in the rigidity of the resultant composition, but an increase in electrical conductivity.

In particular, the crosslinked rubber composition for an outer rubber layer preferably contains an oil in an amount of, for example, 10 parts by weight or more for improving flex fatigue resistance. However, the resultant rubber layer tends to exhibit low rigidity. Thus, specific carbon black is preferably added in an amount of 70 to 100 parts by mass.

In particular, the crosslinked rubber composition for an inner rubber layer preferably contains an oil in an amount of less than 1 part by weight as described above. However, the resultant rubber layer tends to exhibit excessively high rigidity. Thus, specific carbon black is preferably added in an amount of 50 to 80 parts by mass.

The crosslinked rubber composition may contain, besides specific carbon black, an additive to the rubber polymers, for example, an oil, a white filler, a fatty acid, an anti-aging agent, a processing aid, a vulcanizing agent, a vulcanization accelerator, or another component. Examples of the vulcanizing agent include, but are not particularly limited to, sulfur, a peroxide, a quinoid crosslinking agent, a resin crosslinking agent, and a hydrosilicone. Preferred is sulfur or a peroxide.

<2> Brake Hose

No particular limitation is imposed on the layer structure of a brake hose. For example, the layer structure may be in the following form (A) or (B):

(A) a three-layer structure including an outer rubber layer, a reinforcing yarn layer, and an inner rubber layer, wherein these layers are sequentially inwardly disposed in a concentric manner; or

(B) a five-layer structure including an outer rubber layer, an outer reinforcing yarn layer, an intermediate rubber layer, an inner reinforcing yarn layer, and an inner rubber layer, wherein these layers are sequentially inwardly disposed in a concentric manner.

In form (B), the intermediate rubber layer may be formed of the crosslinked rubber composition of the present invention, or may be formed of a conventional crosslinked rubber composition (wherein the rubber polymer is EPDM).

The reinforcing yarn layer is preferably formed by knitting of fiber yarns for improving the pressure resistance of the brake hose. Examples of the material of fiber yarns include, but are not particularly limited to, polyvinyl alcohol (PVA) and polyethylene terephthalate (PET).

### EXAMPLES

[Vulcanized Rubber Composition for Outer Rubber Layer]

In Examples 1 to 6 and Comparative Examples 1 to 6, rubber materials were prepared so as to achieve amounts (represented by “parts by mass”) shown in Table 1 below, and the materials were kneaded, molded, and vulcanized as described below, to thereby produce a vulcanized rubber composition for an outer rubber layer.

TABLE 1
Vulcanized Rubber Composition for Outer Rubber layer

| | | | Comparatve | Comparative | Comparative | Comparative | | |
|---|---|---|---|---|---|---|---|---|
| | | | Example 1 | Example 2 | Example 3 | Example 4 | Example 1 | Example 2 |
| Amounts | Polymer | EPDM | 100 | 50 | | 100 | 70 | 60 |
| | | EBDM | | 50 | 100 | | 30 | 40 |
| | Oil | | 35 | 35 | 35 | 35 | 35 | 35 |
| | Carbon | Seast 116 | 90 | 90 | 90 | | | |
| | Black | SRF grade developed | | | | 90 | 90 | 90 |
| | | product | | | | | | |
| | | Seast S | | | | | | |
| | | Seast SO | | | | | | |
| | Non-electrically Conductive Filler | | 20 | 20 | 20 | 20 | 20 | 20 |
| | Processing Aid | | 8 | 8 | 8 | 8 | 8 | 8 |
| | Vulcanization Accelerator | | 6 | 6 | 6 | 6 | 6 | 6 |
| | Vulcanizing Agent | | 3 | 3 | 3 | 3 | 3 | 3 |
| Properties | Normal-State | HA (Duro-A) | 74 | 75 | 75 | 70 | 69 | 70 |
| | Physical Properties | TB (MPa) | 16.3 | 14.8 | 12.6 | 12.3 | 11.8 | 11.6 |
| | | EB (%) | 510 | 500 | 460 | 500 | 500 | 500 |
| | | M100 (MPa) | 3.90 | 3.90 | 3.77 | 3.36 | 3.54 | 3.54 |
| | Gehman Torsion Test | T10 (° C.) | −49.2 | −53.0 | −56.2 | −48.7 | −51.3 | −51.8 |
| | Volume Specific | Resistance (Ω · cm) | 1.85.E+05 | 9.53.E+04 | 9.30.E+04 | 1.460E+06 | 4.80.E+05 | 2.38.E+05 |
| | Resistance (4 kg) | | | | | | | |
| | De Mattia | Number of Repetitions | No | No | 250,000 | No | No | No |
| | Flex Fatigue | until Breakage process | Breakage | Breakage | times | Breakage | Breakage | Breakage |
| | Resistance | was performed up to | | | | | | |
| | | 500,000 times. | | | | | | |
| | | | | | | Comparative | | Comparative |
| | | | Example 3 | Example 4 | Example 5 | Example 5 | Example 6 | Example 6 |
| Amounts | Polymer | EPDM | 50 | 40 | 30 | | 50 | 50 |
| | | EBDM | 50 | 60 | 70 | 100 | 50 | 50 |
| | Oil | | 25 | 35 | 35 | 35 | 35 | 35 |
| | Carbon | Seast 116 | | | | | | |
| | Black | SRF grade developed | 90 | 90 | 90 | 90 | | |
| | | product | | | | | | |
| | | Seast S | | | | | 90 | |
| | | Seast SO | | | | | | 90 |
| | Non-electrically Conductive Filler | | 20 | 20 | 20 | 20 | 20 | 20 |
| | Processing Aid | | 8 | 8 | 8 | 8 | 8 | 8 |
| | Vulcanization Accelerator | | 6 | 6 | 6 | 6 | 6 | 6 |
| | Vulcanizing Agent | | 3 | 3 | 3 | 3 | 3 | 3 |
| Properties | Normal-State | HA (Duro-A) | 70 | 70 | 69 | 69 | 66 | 73 |
| | Physical Properties | TB (MPa) | 11.4 | 11.3 | 11.1 | 9.7 | 13.1 | 14.2 |
| | | EB (%) | 490 | 480 | 500 | 470 | 500 | 430 |
| | | M100 (MPa) | 3.54 | 3.51 | 3.54 | 3,.6 | 2.92 | 4.11 |
| | Gehman Torsion Test | T10 (° C.) | −52.8 | −53.3 | −54.5 | −57.1 | −52.4 | −51.7 |
| | Volume Specific | Resistance (Ω · cm) | 9.27.E+05 | 2.48.E+05 | 5.95.E+05 | 1.31.E+05 | 5.59.E+05 | 2.84.E+04 |
| | Resistance (4 kg) | | | | | | | |
| | De Mattia | Number of Repetitions | No | No | No | 300,000 | No | No |
| | Flex Fatigue | until Breakage process | Breakage | Breakage | Breakage | times | Breakage | Breakage |
| | Resistance | was performed up to | | | | | | |
| | | 500,000 times. | | | | | | |

Details of used materials are as follows.

EPDM: trade name “EP27” available from JSR Corporation (ethylene content: 54.5% by mass, diene content: 4% by mass).

EBDM: trade name “EBT K-8370EM” available from Mitsui Chemicals, Incorporated (ethylene content: 50% by mass, diene content: 4.7% by mass).

Oil: trade name “P400” (process oil) available from JXTG Energy Corporation.

Carbon black: Table 2 shows four types of carbon black (component, grade, iodine adsorption amount, and DBP absorption amount) and examples of carbon black products belonging to each type. SRF grade carbon and SRF grade developed product (not on sale) correspond to “specific carbon black,” and SRF grade developed product corresponds to “preferred specific carbon black.” Seast 116, Seast SO, Seast S, or SRF grade developed product was used herein.

TABLE 2

| | | Iodine | DBP Absorption | |
|---|---|---|---|---|
| | | Adsorption | Amount (A method) | |
| Component | Grade | Amount [mg/g] | [cm³/100 g] | Eamples of Product |
| MAF grade carbon | MAF grade | 44 to 60 | 122 to 141 | Seast 116 (TOKAI CARBON CO., LTD.) |
| | | | | ASAHI #6O HN (ASAHI CARBON CO., LTD.) |
| FEF grade carbon | FEF grade | 34 to 51 | 100 to 123 | Seast SO (TOKAI CARBON CO., LTD.) |
| | | | | ASAHI #60 U (ASAHI CARBON CO., LTD.) |
| SRF grade carbon | SRF grade | 17 to 33 | 53 to 77 | Seast S(TOKAI CARBON CO., LTD.) |
| | | | | ASAEI #50 (ASAHI CARBON CO., LTD.) |
| | | | | ASAHI #51 (ASAHI CARBON CO., LTD,) |
| SRF grade | SRF grade | 15 to 30 | 100 to 150 | - |
| developed product | | | | |

Non-electrically conductive filler: trade name “Burgess KE” (silane-treated clay) available from Burgess Pigment Company; addition of, for example, silica or talc is optional.

Processing aid: combination use of trade name “Lunac S-50V” (fatty acid) available from Kao Corporation and trade name “EP Tack 100” available from KOBE OIL CHEMICAL INDUSTRIAL Co., Ltd.

Vulcanization accelerator: combination use of trade name “Retarder CTP,” trade name “Nocceler PX-P,” and trade name “Nocceler M-60-OT” available from OUCHI SHINKO CHEMICAL INDUSTRIAL CO., LTD. and trade name “META-Z102” (active zinc flower) available from Inoue Calcium Corporation.

Vulcanizing agent: combination use of trade name “Rhenogran S-80” (sulfur) available from LANXESS and trade name “Nocmaster R-80E” (DTDM) available from OUCHI SHINKO CHEMICAL INDUSTRIAL CO., LTD.

[Vulcanized Rubber Composition for Inner Rubber Layer]

In Examples 7 to 10 and Comparative Examples 7 and 8, rubber materials were prepared so as to achieve amounts (represented by “parts by mass”) shown in Table 3 below, and the materials were kneaded, molded, and vulcanized as described below, to thereby produce a vulcanized rubber composition for an inner rubber layer.

TABLE 3
Vulcanized Rubber Composition for Inner Rubber layer

| | | | Comparative | | | | | Compative |
|---|---|---|---|---|---|---|---|---|
| | | | Example 7 | Example 7 | Example 8 | Example 9 | Example 10 | Example 8 |
| Amounts | Polymer | EPDM | 100 | 60 | 50 | 40 | 30 | 0 |
| | | EBDM | 0 | 40 | 50 | 60 | 70 | 100 |
| | Carbon | SRF grade | 72 | 72 | 72 | 72 | 72 | 72 |
| | | developed product | | | | | | |
| | Processing Aid | | 20 | 20 | 20 | 20 | 20 | 20 |
| | Vulcanization Accelerator | | 9 | 9 | 9 | 9 | 9 | 9 |
| | Anti-aging Agent | | 2 | 2 | 2 | 2 | 2 | 2 |
| | Vulcanizing Agent | | 3 | 3 | 3 | 3 | 3 | 3 |
| Properties | Normal-State | HA (Duro-A) | 78 | 79 | 80 | 80 | 80 | 81 |
| | Physical Properties | TB (MPa) | 9.7 | 9.1 | 8.9 | 8.8 | 8.6 | 7.9 |
| | | EB (%) | 330 | 330 | 350 | 390 | 400 | 390 |
| | | M100 (MPa) | 4.23 | 3.97 | 3.89 | 3.80 | 3.86 | 3.54 |
| | Gelman Torsion Test | T10 (° C.) | −46.8 | −50.5 | −50.8 | −51.6 | −52.0 | −54.6 |
| | Volume Specific | Resistance | 2.82.E +05 | 2.92.E+05 | 1.55.E+05 | 9.39.E+05 | 2.34.E+05 | 9.78.E+04 |
| | Resistance (4 kg) | (Ω · cm) | | | | | | |

Details of used materials are as follows.

EPDM: trade name “EP342” available from JSR Corporation (ethylene content: 47% by mass, diene content: 9% by mass).

EBDM: trade name “EBT K-9330M” available from Mitsui Chemicals, Incorporated (ethylene content: 50% by mass, diene content: 7.2% by mass).

Carbon black: SRF grade developed product shown in Table 2 above.

Non-electrically conductive filler: not added; however, addition of, for example, silica, talc, or clay is optional.

Processing aid: combination use of trade name “Lunac S-50V” available from Kao Corporation and trade name “Vestenamer 8012” (trans-polyoctenamer) available from Huls.

Vulcanization accelerator: combination use of trade name “Retarder CTP,” trade name “Nocceler PX-P,” and trade name “Nocceler M-60-OT” available from OUCHI SHINKO CHEMICAL INDUSTRIAL CO., LTD. and trade name “AZO” (active zinc flower) available from SEIDO CHEMICAL INDUSTRY CO., LTD.

Anti-aging agent: combination use of trade name “Nocrac 224” and trade name “Nocrac MB” available from OUCHI SHINKO CHEMICAL INDUSTRIAL CO., LTD.

Vulcanizing agent: combination use of fine powdery sulfur (200 mesh) and trade name “Vulnoc R” available from OUCHI SHINKO CHEMICAL INDUSTRIAL CO., LTD.

Each of the aforementioned rubber compositions for outer and inner rubber layers was kneaded and molded into a predetermined shape corresponding to the measurements described below. The rubber composition for an outer rubber layer was vulcanized under the condition of 160° C.×10 minutes (15 minutes for only a test piece of de Mattia flex fatigue resistance). The rubber composition for an inner rubber layer was vulcanized under the condition of 160° C.×15 minutes.

Each of the vulcanized rubber compositions of Examples 1 to 10 and Comparative Examples 1 to 8 was evaluated for normal-state physical properties, Gehman torsion test, and volume specific resistance described below. In addition, the vulcanized rubber composition for an outer rubber layer was evaluated for de Mattia flex fatigue resistance.

(1) Normal-State Physical Properties

Hardness (HA) was measured according to JIS K6253 with a type A durometer.

Tensile strength (TB), elongation at break (EB), and tensile stress at 100% elongation (M100) were measured according to JIS K6251: 2017 with “STROGRAPH AE” available from Toyo Seiki Seisaku-sho, Ltd. A dumbbell No. 5 test piece was prepared and subjected to the tensile test at room temperature.

(2) Gehman Torsion Test

The Gehman torsion test was performed according to JIS K6261-3: 2017 with “GEHMAN STIFFNESS TESTER” available from Toyo Seiki Seisaku-sho, Ltd. using a torsion wire of 2.8 mN·m (standard wire) and ethanol as a heating medium. The test was started from −60° C. The reference measurement was performed in air to thereby determine a temperature T10 corresponding to a hardness 10 times that at room temperature.

(3) Volume Specific Resistance

Volume specific resistance was measured according to JIS K6271-1: 2015 with “ULTRA HIGH RESISTANCE METER (R8340A)” and “RESISTIVITY CHAMBER (R12702A)” available from ADVANTEST using a standard double ring electrode (without silver paste). A test piece (length 100 mm, width: 100 mm) was cut out of a molded sheet having a thickness of 2.0 mm, and a voltage 1 V was applied to the test piece for measurement.

(4) De Mattia Flex Fatigue Resistance

De Mattia flex fatigue resistance was evaluated according to JIS K6260: 2017 with “CCD de Mattia flex tester MODEL FT-1513” available from Ueshima Seisakusho Co., Ltd. Flexural deformation was repeatedly applied to a sample at room temperature, and the number of repetitions until breakage of the sample was determined. This process was performed up to 500,000 times. When a sample was not broken after 500,000 repetitions of flexural deformation, the sample was evaluated as “No breakage.”

[Results of Measurement]

The samples of Examples 1 to 10 exhibited a T10 of −50° C. or less as determined by the Gehman torsion test and a volume specific resistance of 1.5×10⁵ Ω·cm or more; i.e., these samples are evaluated as “pass.”

The samples of Examples 1 to 5 and 7 to 10 exhibited a 100% modulus (M100) of 3.2 MPa or more; i.e., these samples are evaluated as “more preferred.”

In contrast, the samples of Comparative Examples 1, 4, and 7 exhibited a high T10, and the samples of Comparative Examples 2, 3, 5, 6, and 8 exhibited a low volume specific resistance.

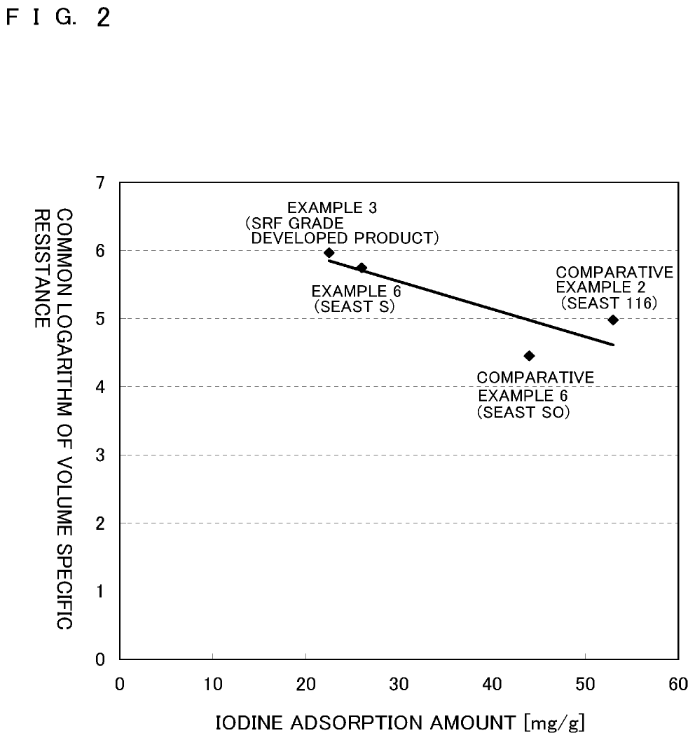

FIG. 2 shows the relationship between the iodine adsorption amount of carbon black used (values published by manufactures, 22.5 mg/g for SRF grade developed product, which is an average of values within a range shown in Table 2) and the common logarithm of the volume specific resistance of a vulcanized rubber composition in each of Examples 3 and 6 and Comparative Examples 2 and 6 (wherein the same components were used, except for the type of carbon black).

[Example of Brake Hose]

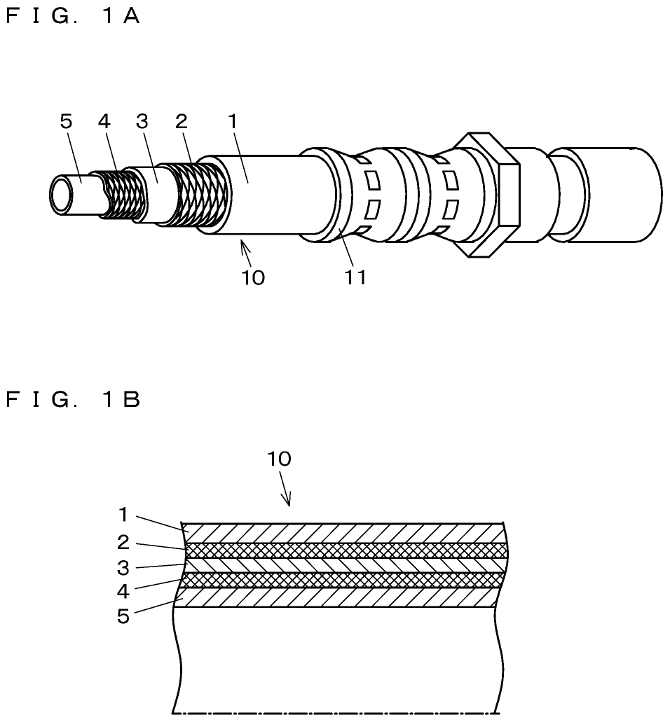

The brake hose 10 shown in FIG. 1 has a five-layer structure including an outer rubber layer 1, an outer reinforcing yarn layer 2, an intermediate rubber layer 3, an inner reinforcing yarn layer 4, and an inner rubber layer 5, wherein these layers are sequentially inwardly disposed in a concentric manner.

The outer rubber layer 1 is formed of any of the crosslinked rubber compositions of Examples 1 to 6.

The intermediate rubber layer 3 is formed of a conventional crosslinked rubber composition (wherein the rubber polymer is EPDM), but may be formed of any of the crosslinked rubber compositions of Examples 1 to 10.

The inner rubber layer 5 is formed of any of the crosslinked rubber compositions of Examples 7 to 10.

The outer reinforcing yarn layer 2 is formed on the outer periphery of the intermediate rubber layer 3 by braid or spiral knitting of, for example, polarity-imparted fiber yarns prepared through epoxy treatment of twisted yarns formed of a polyester fiber material having no polarity.

The inner reinforcing yarn layer 4 is formed on the outer periphery of the inner rubber layer 5 by braid or spiral knitting of fiber yarns similar to those described above.

A metal cap 11 is attached to the end of the brake hose 10 by swaging (i.e., plastic deformation so as to decrease the diameter of the cap).

The brake hose is less likely to cause hardening of the rubber layers 1 and 5, reduction in elasticity, and deterioration of sealability even at low temperatures, and can prevent entrance of a brake fluid from the end of the hose into the outer reinforcing yarn layer 2 or inner reinforcing yarn layer 4 between the rubber layers even when used in a cold area. In addition, the brake hose can achieve low electrical conductivity without deterioration of physical properties (e.g., rigidity) of the rubber layers 1 and 5, and is less likely to cause electrical corrosion at the cap 11 attached to the end of the hose.

The present invention is not limited to the aforementioned examples, and may be appropriately modified and embodied without departing from the spirit of the invention.

### REFERENCE SIGNS LIST

1 Outer rubber layer
2 Outer reinforcing yarn layer
3 Intermediate rubber layer
4 Inner reinforcing yarn layer
5 Inner rubber layer
10 Brake hose
11 Metal cap

1. A crosslinked rubber composition for a brake hose, the crosslinked rubber composition comprising ethylene α-olefin diene rubber and carbon black, wherein:
the ethylene α-olefin diene rubber contains ethylene propylene diene rubber (EPDM) and ethylene butene diene rubber (EBDM), and the mass ratio of EPDM/EBDM is 30/70 to 80/20;
the carbon black contains only specific carbon black exhibiting an iodine adsorption amount of 15 to 33 mg/g and a DBP absorption amount of 50 to 155 cm³/100 g; and
the crosslinked rubber composition exhibits a T10 of −50° C. or less as determined by a Gehman torsion test and a volume specific resistance of 1.5×10⁵ Ω·cm or more.

2. The crosslinked rubber composition for a brake hose according to claim 1, wherein the specific carbon black exhibits an iodine adsorption amount of 15 to 30 mg/g and a DBP absorption amount of 100 to 155 cm³/100 g, and the crosslinked rubber composition exhibits a 100% modulus (M100) of 3.2 MPa or more.

3. A brake hose comprising at least an outer rubber layer, an inner rubber layer, and a reinforcing yarn layer disposed between the outer rubber layer and the inner rubber layer, the brake hose being formed so as to retain a brake fluid inside the inner rubber layer, wherein:
at least one of the outer rubber layer and the inner rubber layer is formed of the crosslinked rubber composition according to claim 1.

4. The brake hose according to claim 3, wherein the specific carbon black of the crosslinked rubber composition exhibits an iodine adsorption amount of 15 to 30 mg/g and a DBP absorption amount of 100 to 155 cm³/100 g, and the crosslinked rubber composition exhibits a 100% modulus (M100) of 3.2 MPa or more.

5. A brake hose comprising at least an outer rubber layer, an inner rubber layer, and a reinforcing yarn layer disposed between the outer rubber layer and the inner rubber layer, the brake hose being formed so as to retain a brake fluid inside the inner rubber layer, wherein:
both the outer rubber layer and the inner rubber layer are formed of the crosslinked rubber composition according to claim 1, and the crosslinked rubber composition for the inner rubber layer contains an oil in an amount of less than 1 part by weight.

6. The brake hose according to claim 5, wherein the specific carbon black of the crosslinked rubber composition exhibits an iodine adsorption amount of 15 to 30 mg/g and a DBP absorption amount of 100 to 155 cm³/100 g, and the crosslinked rubber composition exhibits a 100% modulus (M100) of 3.2 MPa or more.
